(19) United States
(12) Patent Application Publication
(10) Pub. No.: US 2017/0237372 A1
(43) Pub. Date: Aug. 17, 2017

(54) INVERTER MODULE FOR A LOCOMOTIVE

(71) Applicant: Electro-Motive Diesel, Inc., LaGrange, IL (US)

(72) Inventor: Madan M. Jalla, Woodridge, IL (US)

(73) Assignee: Electro-Motive Diesel, Inc., LaGrange, IL (US)

(21) Appl. No.: 15/044,196

(22) Filed: Feb. 16, 2016

(51) Int. Cl. H02P 9/08; B60L 11/12; H02P 3/14; B61C 3/00

(52) U.S. Cl. CPC H02P 9/08; B61C 3/00; B60L 11/12; H02P 3/14; B60L 2210/30

(57) ABSTRACT

The present disclosure provides for a power system for a locomotive. The power system includes an engine, a first alternator, a second alternator and an inverter module. The first alternator operatively coupled to the engine and configured to provide electrical power to one or more traction motors. The second alternator operatively coupled to the engine and configured to provide electrical power to one or more auxiliary loads. The inverter module configured to selectively couple to an energy storage device to provide electrical power to the first alternator for cranking the engine and to a DC link to provide electrical power to the auxiliary load during regenerative braking of the traction motor.

### TECHNICAL FIELD

The present disclosure relates to the field of locomotives. In particular, the present disclosure relates to a power system for a locomotive.

### BACKGROUND

A locomotive possesses kinetic energy while moving and the same must be removed to achieve braking. This removal of kinetic energy from a moving locomotive may be achieved primarily by using friction brakes or dynamic brakes. Both of these brake types convert the kinetic energy into heat energy and dissipate it to achieve braking. The friction brakes use block or pad made of a particular material and apply it against the moving wheels generating heat. The dynamic brakes use the motors providing tractive effort as generating units and dissipate the generated electrical power via resistive grids as heat.

The electrical power dissipated during dynamic braking, even if partially captured, may enhance overall fuel efficiency of a locomotive. The capturing of electrical power during dynamic braking is known as regenerative braking. This captured electrical power may be used to power various systems of locomotive during regenerative braking or may be stored for later use.

A complex electrical power system is required to capture energy during regenerative braking or store it for later use. One of the functions achieved by this captured energy is to power auxiliary loads during regenerative braking. Another function achieved by the captured energy is to crank the engine of the locomotive. All of this requires different electrical devices arranged in a specific manner. The number of such devices and their connections drive cost and complexity into power system of locomotives.

US Patent Application No. 2013/0333635 discloses an assembly for supplying electrical energy to electrical traction motors of a rail vehicle. The document discloses an energy storage unit supplying electrical energy to a generator via a generator inverter to drive the generator in a motorized mode to achieve cranking of internal combustion engine of the rail vehicle.

### SUMMARY OF THE INVENTION

The present disclosure provides for a power system for a locomotive. The power system includes an engine, a first alternator, a second alternator and an inverter module. The first alternator operatively coupled to the engine and configured to provide electrical power to one or more traction motors. The second alternator operatively coupled to the engine and configured to provide electrical power to one or more auxiliary loads. The inverter module configured to selectively couple to an energy storage device to provide electrical power to the first alternator for cranking the engine and to a DC link to provide electrical power to the one or more auxiliary loads during regenerative braking of the one or more traction motors.

The present disclosure further provides for a locomotive. The locomotive includes an engine, a first alternator, a second alternator and an inverter module. The first alternator operatively coupled to the engine and configured to provide electrical power to one or more traction motors. The second alternator operatively coupled to the engine and configured to provide electrical power to one or more auxiliary loads. The inverter module configured to selectively couple to an energy storage device to provide electrical power to the first alternator for cranking the engine and to a DC link to provide electrical power to the one or more auxiliary loads during regenerative braking of the one or more traction motors.

In yet another aspect, a method for operating a locomotive having a first alternator operatively coupled to an engine and configured to provide electrical power to one or more traction motors, a second alternator operatively coupled to the engine and configured to provide electrical power to one or more auxiliary loads and an inverter module. The method includes selectively coupling the inverter module to an energy storage device to provide electrical power to the first alternator for cranking the engine and selectively coupling the inverter module to a DC link to provide electrical power to the one or more auxiliary loads during regenerative braking of the one or more traction motors.

### BRIEF DESCRIPTION OF THE DRAWINGS

FIG. 1 illustrates a side perspective view of a locomotive in accordance with an embodiment.

FIG. 2 illustrates a power system for supplying electrical power in a normal mode to a locomotive in accordance with an embodiment.

FIG. 3 illustrates a power system for supplying electrical power in a cranking mode to a locomotive in accordance with an embodiment.

FIG. 4 illustrates a power system for supplying electrical power in a regenerative mode to a locomotive in accordance with an embodiment.

FIG. 5 illustrates a power system for supplying electrical power in a regenerative mode to a locomotive in accordance with an embodiment.

FIG. 6 illustrates a power system for supplying electrical power in a normal mode to a locomotive in accordance with an embodiment.

FIG. 7 illustrates a method of supplying electrical power to a locomotive in accordance with an embodiment.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts. Also, the term electrical power used anywhere throughout the description may include both alternating current (hereinafter AC) power and direct current (hereinafter DC) power. The term AC power and DC power may include AC and DC power having multiple phases, variable voltages and variable frequencies.

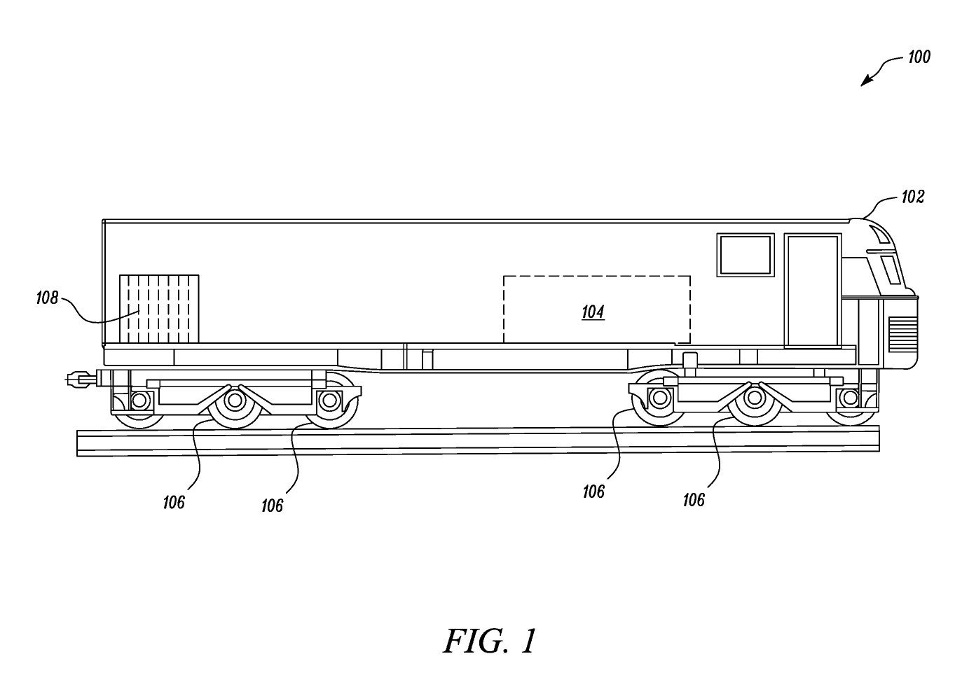

FIG. 1 illustrates an exemplary locomotive 100. The locomotive 100 may include a diesel-electric locomotive or a dual-fueled electric locomotive. The locomotive 100 may include single locomotive, multiple locomotives, a train moved by single locomotive, a train moved by multiple locomotives and any other arrangement of locomotives. As shown in FIG. 1, the locomotive 100 may include a cab 102, an engine compartment 104, at least one wheel 106 and a dynamic brake grid compartment 108. In an embodiment, the wheel 106 may include plurality of wheels. A power system 110 (not shown in FIG.) for supplying electrical power may be placed inside the locomotive 100.

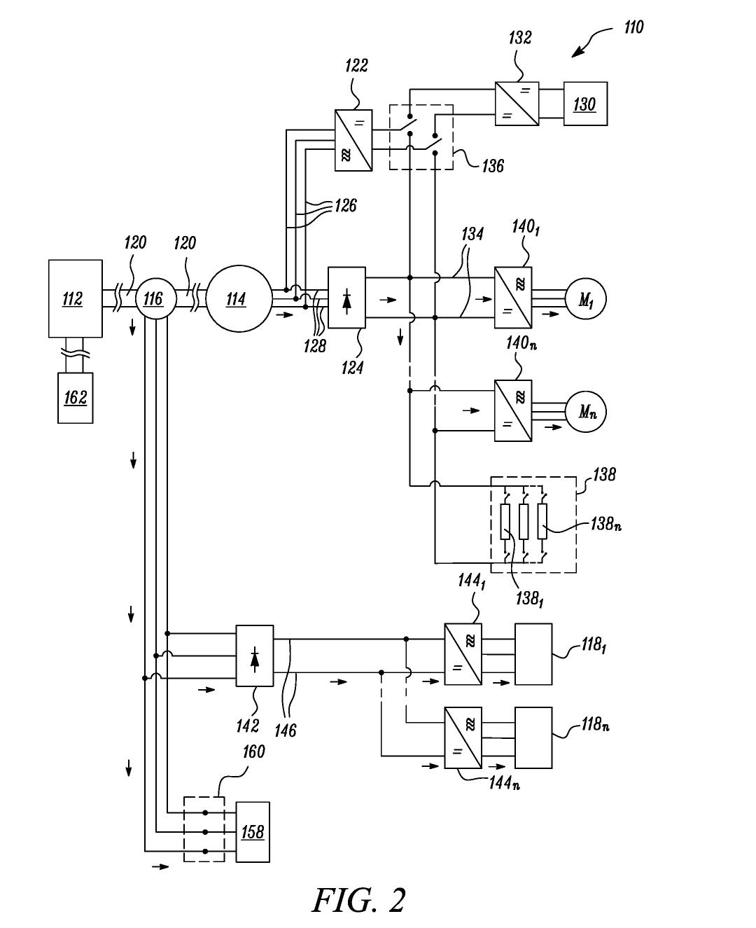

In an embodiment, FIG. 2 shows the power system 110 supplying electrical power to the locomotive 100 (shown in FIG. 1). The power system 110 may supply electrical power to the locomotive 100 (shown in FIG. 1) in a normal mode of operation, a regenerative braking mode of operation and a cranking mode of operation. The power system 110 may include an engine 112, a first alternator 114 and a second alternator 116. The first alternator 114 is operatively coupled to the engine 112 and driven thereby. The first alternator 114 is generating electrical power and providing electrical power to one or more traction motors ‘M’ for driving the wheel 106 (shown in FIG. 1). In an embodiment, the traction motors ‘M’ may be in a motoring mode or in a braking mode. In an embodiment, the one or more traction motors ‘M’ may include plurality of traction motors M₁ to Mₙ. The electrical power generated by the first alternator 114 is 3-phase AC power.

As shown in FIG. 2, the second alternator 116 is operatively coupled to the engine 112 and driven thereby. The second alternator 116 is generating electrical power and providing electrical power to one or more auxiliary loads 118. In an embodiment, the one or more auxiliary loads 118 may include plurality of auxiliary loads 118₁ to 118_{g}. In an embodiment, the auxiliary load 118 may include refrigeration equipment(s), ventilating equipment(s), air conditioning equipment(s), lighting equipment(s), dining facility equipment(s) or any other equipment needing electrical power for its working. The electrical power generated by the second alternator 116 is 3-phase AC power.

In an embodiment, the first alternator 114 and the second alternator 116 may be coupled to the engine 112 in series arrangement via at least one shaft 120. In an embodiment, the first alternator 114 and the second alternator 116 may be coupled to the engine 112 in parallel arrangement via multiple shafts. Further, at least one mechanical load 162 may be coupled to the engine 112. In an embodiment, the mechanical load 162 may be coupled directly or indirectly to the engine 112. A person skilled in the art would appreciate that the coupling of the first alternator 114, the second alternator 116 and the mechanical load 162 to the engine 112 may include other arrangements known/feasible in the art like gear drives, chain drives, belt drives etc.

As shown in FIG. 2, the first alternator 114 may couple to an inverter module 122 and a traction rectifier 124 via a first supply line 126 and a second supply line 128 respectively. The inverter module 122 is coupled to the first alternator 114 to convert 3-phase AC power provided by the first alternator 114 into DC power or to convert DC power received by it into 3-phase AC power and provide it to the first alternator 114. In an embodiment, the inverter module 122 may selectively couple to an energy storage device 130 via a DC-DC Boost converter 132, or to a DC link 134. The selective coupling may be achieved by using at least one switching device 136. The switching device 136 may include switchgear of air-insulated type or gas-insulated type or any other electrically, electronically, mechanically or hydraulically operated switching device. In an embodiment, the energy storage device 130 is battery of the locomotive 100 and it may be charged using the electrical power supplied from the second alternator 116 via an AC-DC converter (not shown in FIG.). In an embodiment, the DC-DC Boost converter 132 may be electrical device to increase voltage of the DC power from the energy storage device 130. As shown in FIG. 2, the inverter module 122 is isolated from both the energy storage device 130 and the DC link 134.

As illustrated in FIG. 2, the traction rectifier 124 is coupled to the first alternator 114 to convert 3-phase AC power supplied from the first alternator 114 into DC power. The converted DC power from the traction rectifier 124 is supplied to the DC link 134. At least one load bank 138 selectively couples to the DC link 134. The load bank 138 may include a resistive, inductive or capacitive load bank. In an embodiment, the load bank 138 is a resistive load bank including resistors converting electrical power into heat. In an embodiment, the load bank 138 may include plurality of load banks 138₁ to 138ₙ connected in parallel or series arrangement.

As shown in FIG. 2, at least one traction inverter 140 may couple to the DC link 134 for converting the DC power to 3-phase AC power and supplying it to the one or more traction motors ‘M’. The traction inverter 140 converts DC power in 3-phase variable voltage variable frequency (hereinafter referred as VVVF) AC power and supplies it to the one or more traction motors ‘M’. In an embodiment, the one or more traction motors ‘M’ are in the motoring mode. In an embodiment, the traction inverter 140 may include plurality of traction inverters 140₁ to 140ₙ supplying 3-phase AC power to plurality of traction motors M₁ to Mₙ.

As shown in FIG. 2, the second alternator 116 may be coupled to the one or more auxiliary loads 118. In an embodiment, the one or more auxiliary loads 118 may include plurality of auxiliary loads 118₁ to 118ₙ. The 3-phase AC power generated by the second alternator 116 is supplied to an auxiliary rectifier 142. The auxiliary rectifier 142 converts 3-phase AC power to DC power and supplies it to at least one auxiliary inverter 144 via an auxiliary DC link 146. In an embodiment, the auxiliary inverter 144 may include plurality of auxiliary inverters 144₁ to 144ₙ supplying 3-phase AC power to plurality of auxiliary loads 118₁ to 118ₙ.

As shown in FIG. 2, a contactor driven auxiliary load 158 may be coupled to both the second alternator 116 and the auxiliary DC link 146 via a contactor switch device 160. The contactor switch device 160 may be in an open position and in a closed position. In an embodiment, the contactor switch device 160 is in a closed position. The contactor driven auxiliary load 158 includes such auxiliary loads on the locomotive 100 (shown in FIG. 1) which are not always online and thus consume energy only when the contactor switch device 160 is in the closed position. Further, at least one mechanical load 162 may be coupled to the engine 112. The mechanical load 162 may be coupled directly or indirectly to the engine 112 via mechanisms known/feasible in the art.

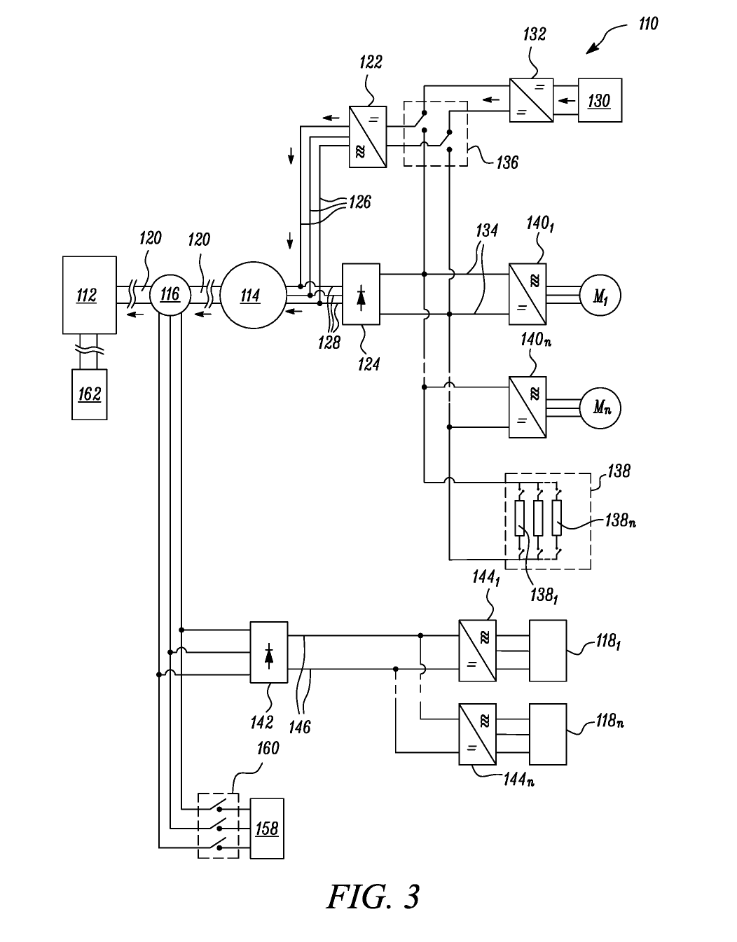

In an embodiment, FIG. 3 shows the power system 110 for supplying electrical power to the locomotive 100 (shown in FIG. 1), wherein the inverter module 122 is coupled to the energy storage device 130 via the DC-DC Boost converter 132. As shown in FIG. 3, electrical power stored in the energy storage device 130 is supplied to the first alternator 114 for cranking the engine 112. As shown in FIG. 3, a contactor driven auxiliary load 158 may be coupled to both the second alternator 116 and the auxiliary DC link 146 via a contactor switch device 160. The contactor switch device 160 may be in an open position and in a closed position. In an embodiment, the contactor switch device 160 is in an open position.

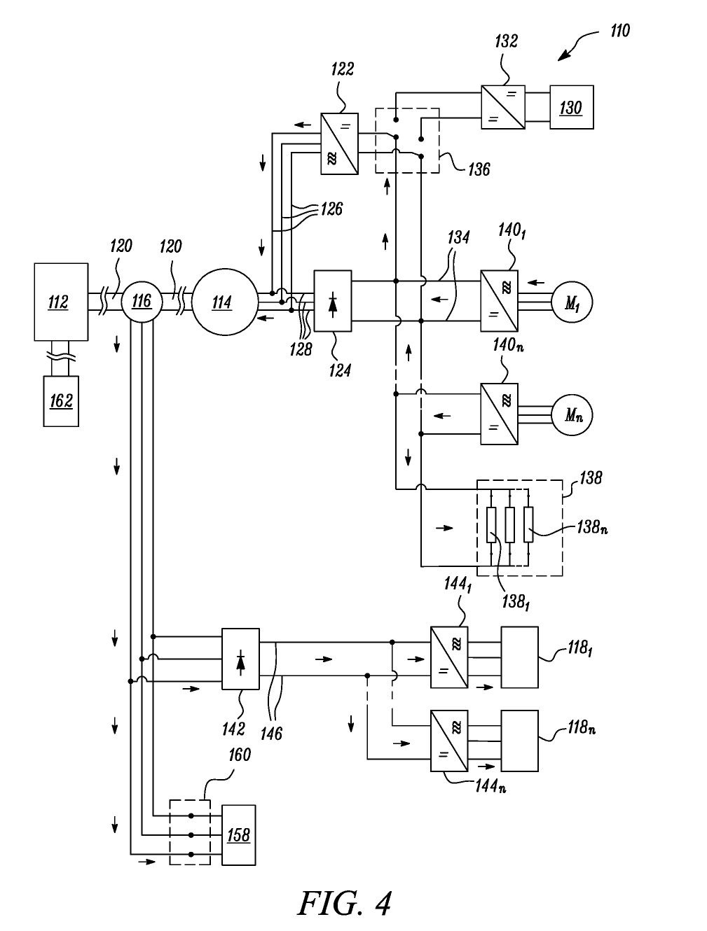

In an embodiment, FIG. 4 shows the power system 110 for supplying electrical power to the locomotive 100 (shown in FIG. 1), wherein the inverter module 122 is coupled to the DC link 134. As shown in FIG. 4, electrical power is generated during regenerative braking of the locomotive 100 (shown in FIG. 1) and is supplied via the DC link 134 to both the second alternator 116 and the load bank 138. Thus, the second alternator 116 works as motor and spins both the engine 112 (fuel supply to the engine 112 is cut-off) and the first alternator 114. The first alternator 114 generates electrical power and both the one or more auxiliary loads 118 and contactor driven auxiliary load 158 are powered by this electrical power. The engine 112 powers the mechanical load 162.

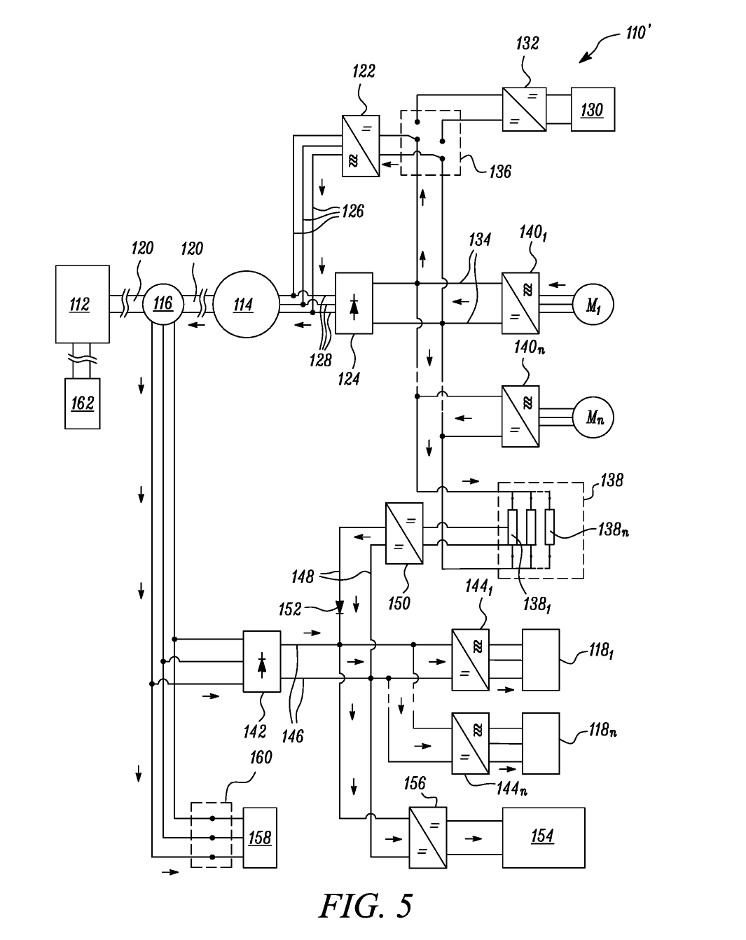

In another embodiment, FIG. 5 shows a power system 110′ for supplying electrical power to the locomotive 100 (shown in FIG. 1). The power system 110′ may supply electrical power to the locomotive 100 (shown in FIG. 1) in the regenerative braking mode of operation. The power system 110′ may include the load bank 138 coupled to the one or more traction motors ‘M’ via the DC link 134. The power system 110′ may also include the one or more auxiliary loads 118 coupled to the second alternator 116 via an auxiliary DC link 146. The power system 110′ may further include an intermediate circuit 148 coupling the load bank 138 to the auxiliary DC link 146 via a DC-DC converter 150. The intermediate circuit 148 may include a one way switch 152. In an embodiment, the one way switch 152 may be a diode or any other electronic device capable of preventing one way flow of electrical power. The one way switch 152 prevents flow of electrical power from the auxiliary DC link 146 to the load bank 138 and enables flow of electrical power from the load bank 138 to the auxiliary DC link 146.

As shown in FIG. 5, the auxiliary DC link 146 may further be coupled to a storage apparatus 154 via a Bi-directional DC converter 156. The storage apparatus 154 stores DC power. In an embodiment, the storage apparatus 154 may include batteries, capacitors, a combination of batteries and capacitors or other storage devices known in the art. The Bi-directional DC converter 156 allows supply of DC power from the auxiliary DC link 146 to the storage apparatus 154 and supply of stored DC power from the storage apparatus 154 to the auxiliary DC link 146. In an embodiment, the storage apparatus 154 is being charged by the DC power during the regenerative mode of operation.

As shown in FIG. 5, a contactor driven auxiliary load 158 may be coupled to both the second alternator 116 and the auxiliary DC link 146 via a contactor switch device 160. The contactor switch device 160 may be in an open position and in a closed position. In an embodiment, the contactor switch device 160 is in a closed position.

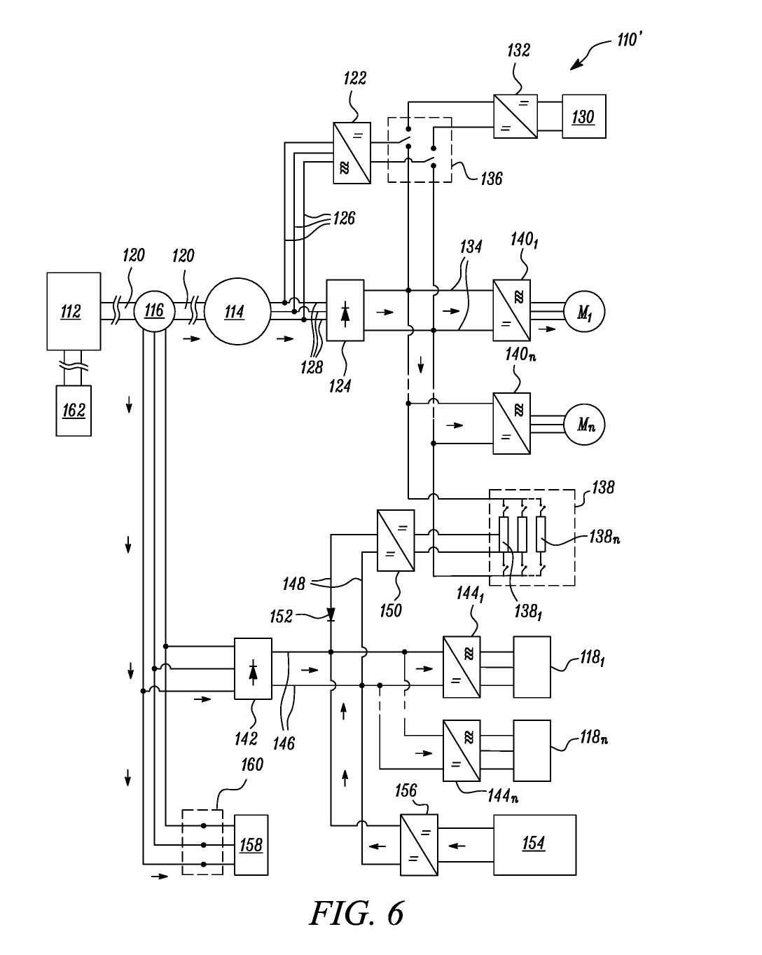

FIG. 6 shows a power system 110′ for supplying electrical power to the locomotive 100 (shown in FIG. 1) in a normal mode of operation. As shown in FIG. 6, the auxiliary DC link 146 may be further coupled to a storage apparatus 154 via a Bi-directional DC converter 156. The storage apparatus 154 stores DC power. In an embodiment, the stored DC power of the storage apparatus 154 may be used to power the one or more auxiliary loads 118. This powering of the one or more auxiliary loads 118 by the storage apparatus 154 is in addition of the electrical power supplied by the second alternator 116. As shown in FIG. 6, a contactor driven auxiliary load 158 may be coupled to both the second alternator 116 and the auxiliary DC link 146 via a contactor switch device 160. The contactor switch device 160 may be in an open position and in a closed position. In an embodiment, the contactor switch device 160 is in a closed position.

### INDUSTRIAL APPLICABILITY

The present disclosure provides for the power system 110 and 110′ supplying electrical power to the locomotive 100. The disclosure provides for the power system 110 and 110′ supplying power to the locomotive 100 during the normal mode of operation, the cranking mode of operation and the regenerative braking mode of operation.

In an aspect of the present disclosure, the power system 110 and 110′ supply electrical power to the locomotive 100. The power system 110 uses the electrical power supplied by the energy storage device 130 and the regenerated electrical power supplied via the DC link 134 exploiting the same inverter module 122, thereby avoiding the need of additional inverters. This keeps the power system 110 simple in construction while avoiding additional costs.

In an aspect of the present disclosure, the power system 110 supplies electrical power to the locomotive 100. The power system 110 utilizes the electrical power supplied by the energy storage device 130 for cranking the engine 112 of the locomotive 100, thereby avoiding installation of a separate cranking equipment. This reduces the overall cost of producing the locomotive 100.

In an aspect of the present disclosure, the power system 110′ uses the storage apparatus 154 to power the one or more auxiliary loads 118 during the normal mode of operation, thereby reducing fuel consumption and increasing overall efficiency of the locomotive 100.

In an aspect of the present disclosure, the power system 110 supplies electrical power to the locomotive 100. Referring to FIG. 2, the power system 110 is in the normal mode of operation. In the normal mode of operation, the engine 112 drives the first alternator 114, the second alternator 116 and the mechanical load 162. The first alternator 114 generates 3-phase AC power. The 3-phase AC power is supplied to the traction rectifier 124 via the second supply line 128. The traction rectifier 124 converts the 3-phase AC power to DC power and supplies it to the DC link 134. The DC link 134 supplies DC power to the traction inverter 140. The traction inverter 140 converts the DC power to 3-phase VVVF AC power and supplies it to the one or more traction motors ‘M’. The one or more traction motors ‘M’ are driven by the 3-phase VVVF AC power to drive the wheel 106 of the locomotive 100. In an embodiment, the one or more traction motors ‘M’ are in the motoring mode.

As shown in FIG. 2, the second alternator 116 also generates 3-phase AC power. The 3-phase AC power from the second alternator 116 is supplied to the energy storage device 130 via the DC-DC Boost converter 132. The 3-phase AC power from the second alternator 116 is also supplied to the contactor driven auxiliary load 158 via contactor switch device 160. The 3-phase AC power generated by the second alternator 116 is also supplied to the auxiliary rectifier 142. The auxiliary rectifier 142 converts 3-phase AC power to DC power and supplies it to the auxiliary inverter 144 via the auxiliary DC link 146. The auxiliary inverter 144 converts the DC power received from the auxiliary DC link 146 to 3-phase AC power and supplies it to power the one or more auxiliary loads 118.

In an aspect of the present disclosure, the power system 110 supplies electrical power to the locomotive 100. Referring to FIG. 3, the power system 110 is in the cranking mode of operation. In the cranking mode of operation, the engine 112 is stopped and needs to be started. The energy storage device 130 supplies DC power having low voltage to the DC-DC boost converter 132. The DC-DC boost converter 132 converts the received DC power to DC power having high voltage and supplies it to the inverter module 122 via the switching device 136. The inverter module 122 converts the high voltage DC power to 3-phase AC power and supplies it to the first alternator 114. The first alternator 114 acts as motor and cranks the engine 112. This obviates the need of any additional cranking equipment to be installed in the locomotive 100.

In an aspect of the present disclosure, the power system 110 supplies electrical power to the locomotive 100. Referring to FIG. 4, the power system 110 is in the regenerative braking mode of operation. In the regenerative braking mode of operation, the locomotive 100 is under dynamic braking employing the one or more traction motors ‘M’ as generators generating 3-phase AC power. In an embodiment, the one or more traction motors ‘M’ are in the braking mode. The 3-phase AC power is supplied to the traction inverter 140. The traction inverter 140 converts the 3-phase AC power to DC power and supplies it to the DC link 134. The DC link 134 supplies the DC power partly to the inverter module 122 via the switching device 136 and partly to the load bank 138. The DC power received by the load bank 138 is dissipated as heat converting the kinetic energy of the locomotive 100 into heat energy.

As shown in FIG. 4, the inverter module 122 converts the DC power to 3-phase AC power and supplies it to the first alternator 114. The first alternator 114 acts as motor and drives the engine 112 and the second alternator 116. As the engine 112 is driven by the first alternator 114 and fuel supply to the engine 112 is cut-off, the mechanical load 162 in essence is powered by the regenerated energy. As the second alternator 116 is driven by the first alternator 114, it generates 3-phase AC power and supplies it to the auxiliary rectifier 142 and the contactor driven auxiliary load 158. The auxiliary rectifier 142 converts the 3-phase AC power to DC power and supplies it to the auxiliary inverter 144 via the auxiliary DC link 146. The auxiliary inverter 144 converts the DC power into 3-phase AC power and supplies it to the one or more auxiliary loads 118.

In an aspect of the present disclosure, the power system 110′ supplies electrical power to the locomotive 100. Referring to FIG. 5, the power system 110′ is in the regenerative braking mode of operation. In the regenerative braking mode of operation, the one or more traction motors ‘M’ act as motor and generate 3-phase AC power. In an embodiment, the one or more traction motors ‘M’ are in the braking mode. The generated 3-phase AC power is supplied to the traction inverter 140. The traction inverter 140 converts the 3-phase AC power to DC power and supplies it to the DC link 134. The DC link 134 supplies the DC power to the load bank 138. The DC power supplied to the load bank 138 is partly supplied to the auxiliary DC link 146 using the intermediate circuit 148 and via a DC-DC converter 150. The residual DC power supplied to the load bank 138 is dissipated as heat inside the load bank 138. The auxiliary DC link 146 supplies the DC power partly to the one or more auxiliary loads 118 via the auxiliary inverter 144 and partly to the storage apparatus 154 via the Bi-directional DC converter 156. The storage apparatus 154 is charged by the DC power supplied by the Bi-directional DC converter 156.

Further referring to FIG. 5, the power system 110′ is in the regenerative mode of operation. In this mode, the engine 112 is non-working i.e. fuel is not being supplied to the engine 112. Therefore, the regenerative energy being supplied to the first alternator 114 to make it act as a motor is used to power the mechanical load 162. Also, the electrical power generated from the second alternator 116 is used to power the contactor driven auxiliary load 158 via the contactor switch device 160.

In an aspect of the present disclosure, the power system 110′ supplies electrical power to the locomotive 100. Referring to FIG. 6, the power system 110′ is in the normal mode of operation. In the normal mode of operation, the engine 112 drives the first alternator 114 and the second alternator 116. The first alternator 114 generates 3-phase AC power. The 3-phase AC power is supplied to the traction rectifier 124 via the second supply line 128. The traction rectifier 124 converts the 3-phase AC power to DC power and supplies it to the DC link 134. The DC link 134 supplies DC power to the traction inverter 140. The traction inverter 140 converts the DC power to 3-phase VVVF AC power and supplies it to the one or more traction motors ‘M’. The one or more traction motors ‘M’ are driven by the 3-phase VVVF AC power to drive the wheel 106 of the locomotive 100. In an embodiment, the one or more traction motors ‘M’ are in the motoring mode.

As shown in FIG. 6, the second alternator 116 also generates 3-phase AC power. The 3-phase AC power generated by the second alternator 116 is supplied to the auxiliary rectifier 142. The auxiliary rectifier 142 converts 3-phase AC power to DC power and supplies it to the auxiliary inverter 144 via the auxiliary DC link 146. The auxiliary inverter 144 converts the DC power from the auxiliary DC link 146 to 3-phase AC power and supplies it to power the one or more auxiliary loads 118. Additionally, the DC power stored in the storage apparatus 154 is supplied to the auxiliary DC link 146 via the Bi-directional DC converter 156. The DC power is then supplied by the auxiliary DC link 146 to power the one or more auxiliary loads 118 in addition to the power supplied by the second alternator 116. The DC power may be also used to power the one or more auxiliary loads 118 alone to avoid the scarcity of available power as the power from the second alternator 116 is also required for powering the contactor driven auxiliary load 158. The one way switch 152 in the intermediate circuit 148 prevents the flow of DC power from the auxiliary DC link 146 in the load bank 138. This prevention of flow of DC power by the one way switch 152 further improves overall efficiency of the locomotive 100 as it avoids dumping and dissipating of the DC power in the load bank 138.

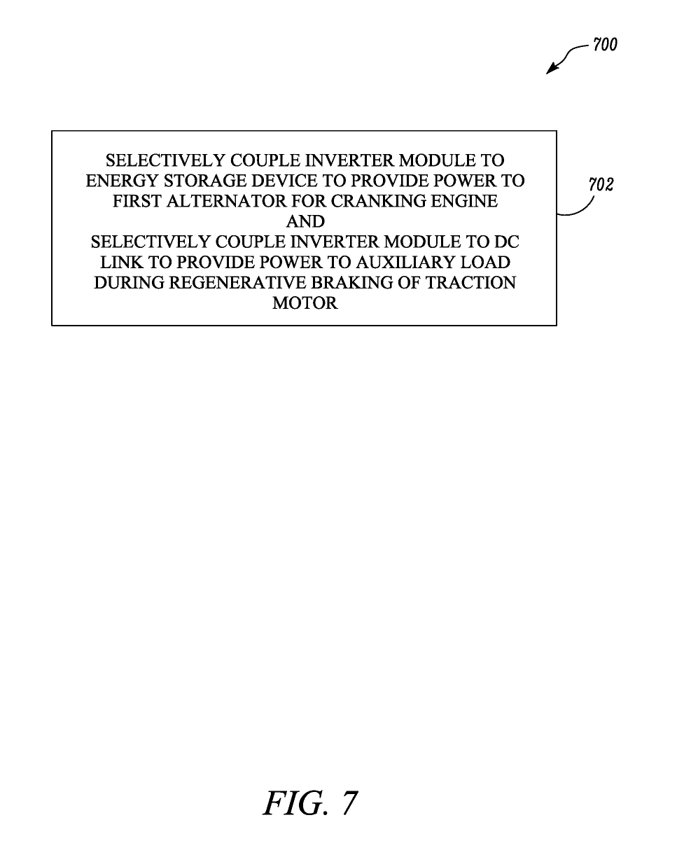

In yet another aspect of the present disclosure, a method 700 for operating the locomotive 100 having the first alternator 114 powering the one or more traction motors ‘M’, the second alternator 116 powering the one or more auxiliary loads 118 and the inverter module 122 is disclosed. Referring to FIG. 7, the method 700 includes the following steps. In step 702, the inverter module 122 is selectively coupled to the energy storage device 130 to provide electrical power to the first alternator 114 for cranking the engine 112 and to the DC link 134 for providing electrical power to the one or more auxiliary loads 118 during regenerative braking of the one or more traction motors ‘M’.

What is claimed is:

1. A power system for a locomotive, the power system comprising:
an engine;
a first alternator operatively coupled to the engine and configured to provide electrical power to one or more traction motors;
a second alternator operatively coupled to the engine and configured to provide electrical power to one or more auxiliary loads;
an inverter module configured to selectively couple to:
an energy storage device to provide electrical power to the first alternator for cranking the engine; and
a DC link to provide electrical power to the one or more auxiliary loads during regenerative braking of the traction motor.

2. The power system of claim 1, wherein the power system includes an auxiliary DC link to provide electrical power from the second alternator to the one or more auxiliary loads.

3. The power system of claim 2, wherein the power system includes a load bank coupled to the DC link.

4. The power system of claim 3, wherein the load bank and the auxiliary DC link are coupled together by an intermediate circuit.

5. The power system of claim 4, wherein the intermediate circuit includes a one way switch to prevent flow of electrical power from the auxiliary DC link to the load bank.

6. The power system of claim 5, wherein the one way switch is a diode.

7. The power system of claim 1, wherein the one or more traction motors operate in one of a motoring mode or in a braking mode.

8. A locomotive comprising:
an engine;
a first alternator operatively coupled to the engine and configured to provide electrical power to one or more traction motors;
a second alternator operatively coupled to the engine and configured to provide electrical power to one or more auxiliary loads;
an inverter module configured to selectively couple to:
an energy storage device to provide electrical power to the first alternator for cranking the engine; and
a DC link to provide electrical power to the one or more auxiliary loads during regenerative braking of the traction motor.

9. The locomotive of claim 8, wherein the locomotive includes an auxiliary DC link to provide electrical power from the second alternator to the one or more auxiliary loads.

10. The locomotive of claim 9, wherein the locomotive includes a load bank coupled to the DC link.

11. The locomotive of claim 10, wherein the load bank and the auxiliary DC link are coupled together by an intermediate circuit.

12. The locomotive of claim 11, wherein the intermediate circuit includes a one way switch to prevent flow of electrical power from the auxiliary DC link to the load bank.

13. The locomotive of claim 12, wherein the one way switch is a diode.

14. The locomotive of claim 8, wherein the one or more traction motors operate in one of a motoring mode or in a braking mode.

15. A method for operating a locomotive, the locomotive includes a first alternator operatively coupled to an engine and configured to provide electrical power to one or more traction motors, a second alternator operatively coupled to the engine and configured to provide electrical power to one or more auxiliary loads, and an inverter module, the method comprising:
selectively coupling the inverter module to:
an energy storage device to provide electrical power to the first alternator for cranking the engine; and
a DC link to provide electrical power to the one or more auxiliary loads during regenerative braking of the traction motor.

16. The method of claim 8, wherein the locomotive includes an auxiliary DC link to provide electrical power from the second alternator to the one or more auxiliary loads.

17. The method of claim 9, wherein the locomotive includes a load bank coupled to the DC link.

18. The method of claim 10, wherein the load bank and the auxiliary DC link are coupled together by an intermediate circuit.

19. The method of claim 11, wherein the intermediate circuit includes a one way switch to prevent flow of electrical power from the auxiliary DC link to the load bank.

20. The method of claim 15, wherein the one or more traction motors work in a motoring mode or in a braking mode.
